(19) United States
(12) Patent Application Publication
(10) Pub. No.: US 2022/0173676 A1
(43) Pub. Date: Jun. 2, 2022

(54) METHOD FOR THE VIBRATION- AND NOISE-REDUCED OPERATION OF AN ELECTRIC-MOTOR DEVICE AND ELECTRIC-MOTOR DEVICE

(71) Applicant: NIDEC DRIVEXPERT GMBH, Ilmenae (DE)

(72) Inventors: Sandro Purfuerst, Ilmenau (DE); Robert Reichert, Ilmenau (DE)

(21) Appl. No.: 17/436,796

(22) PCT Filed: Feb. 27, 2020
(86) PCT No.: PCT/DE2020/000039

§ 371 Date: Sep. 7, 2021

(30) Foreign Application Priority Data
Mar. 4, 2019 (DE) 10 2019 001 461.8

(51) Int. Cl. H02P 6/10; A47J 43/08; B60J 7/057

(52) U.S. Cl. CPC H02P 6/10; H02P 2207/05; B60J 7/0573; A47J 43/085

(57) ABSTRACT

A vibration and noise-reduced electric-motor device for an electrical household appliance or an electrical sliding roof. The invention includes a method for the vibration and noise-reduced operation of an electric-motor device. The electric-motor device has an electric-motor assembly, a main body, and a driven group of accessories. The electric motor assembly includes an electric motor, a control and evaluation unit, a data memory, a current regulator, a rotor angle sensor and a torque evaluator. The electric motor has a stator, a rotor and motor coils. In the method, a setpoint current stored in a value table in the data memory is applied to the motor coils in accordance with the rotor angle. The torque deviation resulting at the setpoint current, between the setpoint torque and the actual torque is determined, and an optimized new setpoint current value is calculated by interpolation and is written into the value table.

The invention relates to a method for the vibration- and noise-reduced operation of an electric-motor device and a vibration- and noise-reduced electric-motor device, in particular a vibration- and noise-reduced electrical household appliance and a vibration- and noise-reduced sliding or lifting roof of an automobile.

Electric-motor devices such as electrical household appliances and electrical sliding or lifting roofs for automobiles are known as such from the state of the art.

Since these electric-motor devices are operated in the immediate vicinity of the operators, in particular in the immediate vicinity of their head and ears, noise generation from electrical household appliances and electrical sliding or lifting roofs are particularly disadvantageous. According to the prior art, it is therefore known to reduce the noise emission by encapsulating the electric motors with sound-absorbing materials. The disadvantage of this method is that, on the one hand, the heat of the electric motor is more difficult to dissipate and, on the other hand, despite encapsulation, vibrations are transmitted to a driven group of accessories or a main body, which can be emitted as noise from there. Furthermore, control methods are known which modulate the phase current in order to achieve a reduction in running noise. Here, the disadvantage is that either a complex adjustment to the respective motor must be performed, that an adjustment to changing loads of the electric motors is only possible to a limited extent, or that the running noise reduction is not optimized.

The task of the invention is to provide a method for operating an electric-motor device which can be applied with little effort to different variants of electric-motor devices and which effectively reduces the noise level. Furthermore, it is the task of the invention to provide an electric-motor device, in particular an electrical household appliance and an electrical vehicle roof, which are designed to perform a vibration- and noise-reduced operation.

With respect to the method, the task is solved by the features specified in claim 1. With regard to the device, the task is solved by the features specified in claim 3. Preferred further embodiments result from the corresponding subclaims.

The method for the vibration- and noise-reduced operation of an electric-motor device is carried out by means of an electric-motor device having the features described below.

The electric-motor device for carrying out the method has an electric-motor assembly, a main body and a driven group of accessories.

The electric motor of the electric-motor assembly is arranged in a defined positional relationship to the main body. The main body is designed, for example, as a housing or frame and defines the positional relationship of the electric motor and the driven group of accessories. The driven working assembly takes up the rotational movement provided by the electric motor and carries out the target movement, wherein a transformation can optionally be provided by a gear. In the case of an electrical kitchen equipment, the driven group of accessories may, for example, comprise a cutting or chopping mechanism. In the case of an electrical sliding or lifting roof of a vehicle, the driven working assembly has, in particular, a gear unit and a mechanism for changing the position of the movable roof part.

According to the invention, the electric-motor assembly comprises the electric motor, a control and evaluation unit, a data memory, a current regulator a rotor angle sensor and a torque evaluator.

The data memory, the current regulator, the rotor angle sensor and the torque evaluator are each connected to the control and evaluation unit.

The control and evaluation unit is designed to receive data from the rotor angle sensor and torque evaluator and to process them. Furthermore, the control and evaluation unit is designed to control the current regulator and to read data from and write data in the data memory. The control and evaluation unit is preferably an electronic circuit such as a computer or a controller. In particular, the data memory, the torque evaluator and the current regulator can form an integrated structural unit together with the control and evaluation unit.

According to the invention, the electric motor comprises a stator, a rotor and motor coils. The rotor is preferably located inside a rotational-symmetric stator and is pivoted about a rotational axis. The stator or the rotor or both components comprise soft magnetic material in a tooth structure. Hereinafter, the teeth are also referred to as stator teeth and rotor teeth. In the following, the rotor teeth are also referred to in part as rotor arms. Preferably, the motor coils are arranged on the stator symmetrically around the rotational axis of the rotor on the stator teeth.

The electric motor comprises a commutation by means of an electronic circuit and can be designed in various ways, for example as a brushless DC motor. Preferably, it is a switched reluctance motor. Such a reluctance motor is designed such that a magnetic flux is generated by the rotor when an electric current is applied to the motor coils. The reluctance force aligns the rotor teeth with the stator teeth in such a way that the magnetic resistance is reduced. Thus, the geometric arrangement of the rotor teeth and stator teeth relative to each other causes the rotor to rotate. By switching on and off the motor coils at different stator teeth, such a magnetic flux is generated again and again and causes the rotor to align itself to minimize the magnetic resistance. Hereinafter, the switched reluctance motor is also referred to, sometimes abbreviated, merely as the reluctance motor or motor.

The method according to the invention is based on the finding that the rotor teeth and the stator teeth deform in particular transversely to their longitudinal axes as a result of the force acting on them, in the case of a reluctance motor it is the reluctance force. This deformation leads to vibrations of the rotor teeth and the stator teeth as well as sometimes other mechanically connected components of the reluctance motor or a driven group of accessories, which are perceived as noise in the audible frequency range. To reduce the vibration and consequently the noise, the method provides a solution according to which the force to the rotor teeth and stator teeth is controlled such that their vibration is reduced. For this purpose, the torque is kept as constant as possible in all angular positions of the rotor. This means that substantially constant forces act on the rotor teeth and stator teeth transversely to their longitudinal axes. The method provides a solution that is not bound to a specific geometry and other structural design of the rotor teeth and stator teeth.

According to the invention, the method includes the following steps:

a) Definition of a value table in the data memory which comprises several table points, the table points being formed as value tuples. Each of the value tuples contains a pair of values from a setpoint torque and a rotor angle as well as an assigned setpoint current.

b) Performance of a partial cycle

b)1 Specification of a setpoint torque

b)2 Detection of a first actual rotor angle by the rotor angle sensor

b)3 By the control and evaluation unit, read-out of the setpoint current which is assigned to the first pair of values from the setpoint torque and the first actual rotor angle. Here, the two table points closest to the specified setpoint torque and the two table points closest to the actual rotor angle are determined and the distance of the real values of the setpoint torque and the first actual rotor angle to the table points is calculated. The setpoint current is determined by bilinear interpolation from the respective setpoint currents of the four table points.

b)4 Setting of the setpoint current by the current regulator

b)5 Application of current to the motor coils

b)6 Evaluation of the actual torque by the torque evaluator

b)7 Determination of a torque deviation by the control and evaluation unit by comparing the setpoint torque and the actual torque

b)8 Calculation of a corrected setpoint current by the control and evaluation unit on the basis of the torque deviation. The calculation is done for all four table points most recently used as a function of the interpolation distance used.

b)9 Entry of the calculated values of the corrected setpoint current in the four relevant value tuples of the value table by the control and evaluation unit and deletion of the previous values of the setpoint current

c) Repeated performance of the partial cycle until a rotor angle corresponding to a complete motor state is reached, thus forming a complete cycle

d) Repeated performance of a complete cycle.

In the following, the method is described in detail with reference to the procedural steps:

a) Definition of a value table

An example of a corresponding value table is shown in Table 1.

Setpoint currents are assigned to each a rotor angle (Θ_{ist (actual)}) and the setpoint torque for the respective motor coil to be energized. A table point forms a value tuple which comprises the rotor angle (Θᵢₛₜ), the setpoint torque (M_{Soll (setpoint)}) and at least one setpoint current, or preferably two setpoint currents, in particular one setpoint current for each of the two adjacent motor coils (I₁, I₂).

Table 1 shows a value table for an electric motor with two coils. For an electric motor with more coils, the value tuples contain additional setpoint current values for each additional coil.

This value table is stored in the data memory. The control and evaluation unit is configured to access the data memory and the value table.

b) Performance of a partial cycle

b)1 Specification of a setpoint torque

The specification of a setpoint torque is determined by the load to be provided by the motor for providing the motion of the driven group of accessories. The setpoint torque is specified by the control and evaluation unit during the starting process of the electric motor.

b)2 Detection of a first actual rotor angle by the rotor angle sensor

The rotor angle sensor measures the mechanical angular position of the rotor. In this way, it is known how the rotor teeth and the stator teeth are positioned relative to each other. Thus, the rotor angle sensor also determines the position of the rotor within a motor state.

b)3 Read-out of the setpoint current by the control and evaluation unit

The control and evaluation unit reads out the setpoint currents to the closest rotor angles and the setpoint torque from the value table of the data memory. The values of the four nearby table points which have been read out are set off against the real values, and the distance of the real values of the setpoint torque and the first actual rotor angle to the table points is determined. An example of four determined points is highlighted by a frame in the value table.

Bilinear interpolation is used to calculate the setpoint currents from the respective setpoint currents of the four table points.

b)4 Setting of the setpoint currents by the current regulator

The current regulator sets the calculated setpoint currents for the respective motor coils. It can be any type of current regulators known from the prior art which have sufficiently fast switching times. Preferably, it is a digital current regulator.

b)5 Application of current to the motor coils

The current regulator leads the setpoint current to the corresponding motor coil so that a magnetic flux is generated and consequently a force is applied to the rotor.

b)6 Evaluation of the actual torque by the torque evaluator

The torque evaluator evaluates the actual torque. Preferably, the actual torque is determined from the available parameters such as the actual currents and the rotor angle.

b)7 Determination of a torque deviation by the control and evaluation unit

The control and evaluation unit determines a torque deviation by comparing the setpoint torque with the actual torque.

b)8 Calculation of a corrected setpoint current by the control and evaluation unit on the basis of the torque deviation

A detected torque deviation results in the finding that the level of the setpoint current was not completely suitable for setting the specified setpoint torque. Simultaneously, the size of the detected torque deviation provides a statement as to the extent to which a changed setpoint current would probably cause the actual torque corresponding to the setpoint torque.

According to the invention, the calculation is carried out for all four table points most recently used. The calculation is carried out as a function of the interpolation distance (h, I) used and the torque deviation (Mₛₒₗₗ-Mᵢₛₜ). Furthermore, a learning constant (K_{Lern (Learn)}) is included in the calculation.

b)9 Entry of the calculated values of the corrected setpoint current in the four relevant value tuples of the value table by the control and evaluation unit and deletion of the previous values of the setpoint current

The control and evaluation unit writes the values determined for the corrected setpoint currents in the value tuples of the four table points.

c) Repeated performance of the partial cycle until a motor angle corresponding to a complete motor state is reached

The operating phase of the motor from one commutation to the next commutation is referred to as a motor state. In this process, the rotor runs through all angular positions, starting from the angular position of one commutation to the next commutation. The angular position of the rotor at the end of a motor state equals the angular position at the start of the next motor state.

The partial cycle is repeated until the rotor of the electric motor has reached a rotation angle that corresponds to a congruent position to the rotation angle at the start of the next motor state. Depending on the number of arms of the rotor, it always reaches a congruent position for such a motor state after an angle that corresponds to 360° divided by the number of motor states. Herre, the rotor is assumed to be a rotational-symmetric one.

In the case of a three-arm rotor, a motor state is terminated every 120°. A complete cycle is thus achieved. Thus, a complete cycle is the sum of all partial cycles performed from the start of a motor state to the termination of a motor state.

After reaching the first motor state, the partial cycle is also performed for the next motor state and repeated until a complete cycle is reached again.

d) Repeated performance of a complete cycle

The procedure is repeated for all subsequent complete cycles.

For a complete rotation of the rotor by 360°, three motor states and thus three complete cycles are performed for a three-arm rotor. For each motor state, a partial cycle is performed again and again until a complete cycle is reached again.

In the example according to Table 1, a first motor state is completed after a rotation of the rotor by 60°. For a complete rotor rotation of 360°, six motor states and thus six complete cycles are run through.

This is repeated continuously to achieve a permanent rotation of the rotor.

The method according to the invention offers in particular the following special advantages.

The method is iteratively self-learning. With each run of a partial cycle, the table points referred to the value of the setpoint current are optimized. With continued execution of the method, all table points are covered by the optimization. By means of repeated execution, the setpoint current more and more approximates to the optimum value so that the torque deviation approaches asymptotically zero.

Due to the continuously improving torque setting, a particularly smooth running and major noise reduction is achieved as an advantage.

Furthermore, it is advantageous that the method can be used for different motors without requiring adjustment or with only little adjustment effort. It is only necessary to initially set the value table with roughly determined values, which only have to enable the motor to run. When applying the method, each run of the partial cycles and the complete cycle leads to an automatic optimization of the values of the setpoint current in adjustment to the respective motor.

It is also advantageous that the method automatically compensates for any manufacturing tolerances.

Another advantage is given by the fact that the method provides automatic adjustment to changes that may only occur successively in the course of the motor operation, such as imbalances or irregular running due to the wear of the bearings. The method has the effect that the setpoint currents are adjusted to the respective physical condition of the motor, to the wearing condition in particular.

Moreover, there is the advantage that the driven group of accessories is only exposed to low vibrations and thus lower dynamic loads. This can additionally increase its service life.

The method according to the invention is of particular advantage if the electric-motor device is an electric kitchen appliance, such as a mixer or a multifunctional appliance with a chopping/dicing mechanism, or an electric sliding or lifting roof of an automobile. In these cases, the electric-motor device is in close proximity to the human ear so that noise reduction is particularly important.

According to an advantageous further development, the value table is designed for a complete rotor rotation.

If the value table is designed for a complete rotor rotation, i.e., for a rotation of 360°, table points are assigned to each physical positional relation of a rotor tooth to a stator tooth in a reversibly clear manner. In this way, the method can compensate for even the finest manufacturing differences in the individual rotor or stator teeth, imbalances or signs of wear of the rotor. As a result, the running smoothness of the electric motor can be additionally increased and guaranteed even after long running times.

The electric-motor device comprises an electric motor assembly, a main body and a driven group of accessories.

The contents of the description in the preceding sections relating to the electric-motor assembly, the main body and the driven working group in connection with the method according to the invention also apply in the same way to the electric-motor assembly, the main body and the driven group of accessories as components of the electric-motor device according to the invention. Reference is hereby made to the contents of these descriptions.

In compliance with the electric-motor device according to the invention, the electric-motor assembly is designed to perform the following steps:

a) Storage of a value table in the data memory which comprises several table points, the table points being formed as value tuples. Each of the value tuples contains a pair of values from a setpoint torque and a rotor angle as well as an assigned setpoint current.

b) Performance of a partial cycle

b)1 Specification of a setpoint torque

b)2 Detection of a first actual rotor angle by the rotor angle sensor

b)3 By the control and evaluation unit, read-out of the setpoint current which is assigned to the first pair of values from the setpoint torque and the first actual rotor angle. The closest two table points to the specified target torque and the closest two table points to the actual rotor angle are determined and the distance of the real values of the setpoint torque and the first actual rotor angle to the table points is calculated. The setpoint current is determined by bilinear interpolation from the respective setpoint currents of the four table points.

b)4 Setting of the setpoint current by the current regulator

b)5 Application of current to the motor coils

b)6 Evaluation of the actual torque by the torque evaluator

b)7 Determination of a torque deviation by the control and evaluation unit by comparing the setpoint torque and the actual torque

b)8 Calculation of a corrected setpoint current by the control and evaluation unit on the basis of the torque deviation. The calculation is carried out for all four table points most recently used as a function of the interpolation distance used.

b)9 Entry of the calculated values of the corrected setpoint current in the four relevant value tuples of the value table by the control and evaluation unit and deletion of the previous values of the setpoint current

c) Repeated performance of the partial cycle until a rotor angle corresponding to a complete motor state is reached, thus forming a complete cycle

d) Repeated performance of a complete cycle.

The descriptions of the procedural steps in the description section for the method according to the invention apply in the same way to the design of the electric-motor assembly for providing the above steps.

Precisely, the data memory is designed to store a table of values with table points. Here, the table points are formed by value tuples, each value tuple having a value pair comprising a setpoint torque and a rotor angle and an assigned setpoint current.

The rotor angle sensor is designed to detect an actual rotor angle and to transmit it to the control and evaluation unit and to the torque evaluator.

The control and evaluation unit is designed to read out, from the data memory from the value table stored there, a setpoint current which is assigned to the value pair of the setpoint torque and the first actual rotor angle. Specifically, the control and evaluation unit is designed to determine the closest table points, to calculate the distance of the real values of the setpoint torque and the first actual rotor angle to the table points and to calculate the setpoint current by bilinear interpolation from the respective setpoint currents of the four table points.

The current regulator is designed to set a setpoint current, which is specified by the control and evaluation unit, for energizing the motor coils.

The torque evaluator is designed to evaluate an actual torque and to transmit the determined actual torque to the control and evaluation unit.

Furthermore, the control and evaluation unit is designed to determine a torque deviation by comparing the actual torque obtained from the torque evaluator with the setpoint torque, to calculate a corrected setpoint current on the basis of the torque deviation and to write it for the four table points most recently used as a ii function of the interpolation distance into the value table in the data memory.

The electric-motor device according to the invention has the following advantages in particular.

A particularly high degree of running smoothness and noise reduction is achieved with little device-related effort. In particular, it is advantageous that the running smoothness and the noise reduction continue to improve with continued operation, since the setpoint current continues to approximate to the optimum value and the torque deviation is asymptotically set to zero.

The requirements on the manufacturing accuracy of the physical motor components as well as the driven group of accessories can be reduced, as the device provides automatic compensation for any manufacturing tolerances.

The device according to the invention also ensures automatic adjustment to changes that gradually occur in the course of operation of the arrangement, such as imbalances or irregular running due to bearing wear, by adjusting the setpoint currents to the respective physical condition of the motor, in particular the condition of wear and tear.

Without additional manufacturing effort, the service life of the electric-motor device can be increased, since the driven group of accessories is only subject to low vibrations and thus to lower dynamic loads.

Furthermore, all advantages relating to the method also apply appropriately to the electric-motor device.

According to an advantageous further development of the electric-motor device, it is designed as a household appliance operated by an electric motor. In this context, household appliances include in particular, but are not limited to, mixers, blenders, stirrers, coffee grinders, multifunctional appliances with food-crushing mechanisms, and vacuum cleaners.

These household appliances are usually hand-guided or hand-held during operation so that the operator is always in close proximity. Therefore, the noise reduction as well as the vibration reduction are particularly advantageous.

According to a further advantageous development, the electric-motor device is designed as a household appliance driven by an electric motor, wherein the driven group of accessories comprises a food-crushing mechanism. In particular, this may be a chopping mechanism such as the one integrated in a mixer or blender or in a multifunctional appliance, or a grinding mechanism.

A particular advantage is given by the fact that apart from the aspect of manual guidance of such devices and the resulting spatial proximity to an operator, a particularly effective noise reduction is possible with the usually very fast-running electric motors of these devices.

According to another advantageous further development, the electric-motor design is provided as an electric vehicle roof. An electric vehicle roof is understood to be a sliding roof, a lifting roof or a sliding and lifting roof operated by an electric motor.

Since such electric vehicle roofs are arranged directly above the driver's head, there is a particularly small distance to the ears so that operating noises are perceived very intensively and can impair the driver's concentration. Advantageously, the noise reduction achieved is particularly effective.

The invention is explained in more detail by way of example with reference to the following figures. They show:

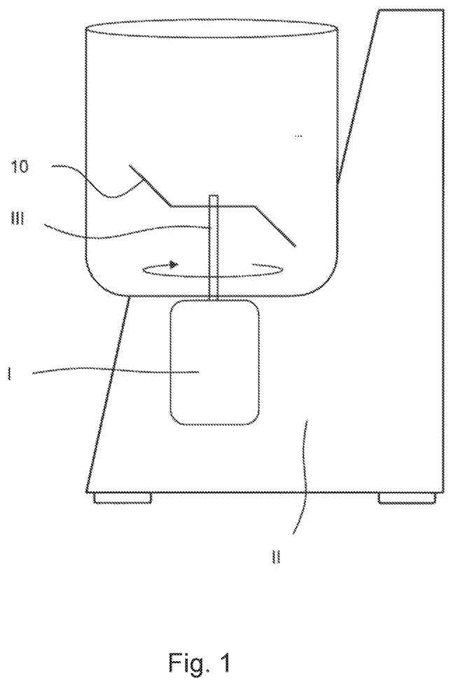

FIG. 1 Schematic representation of an electric-motor device as a household appliance

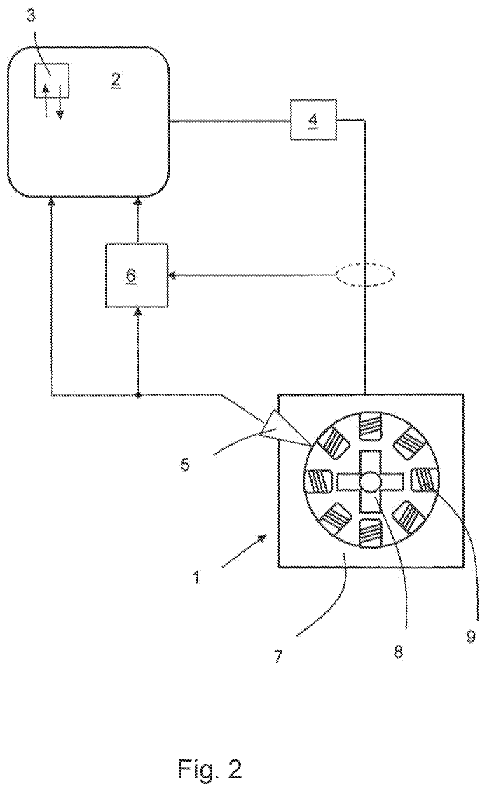

FIG. 2 Electric-motor assembly

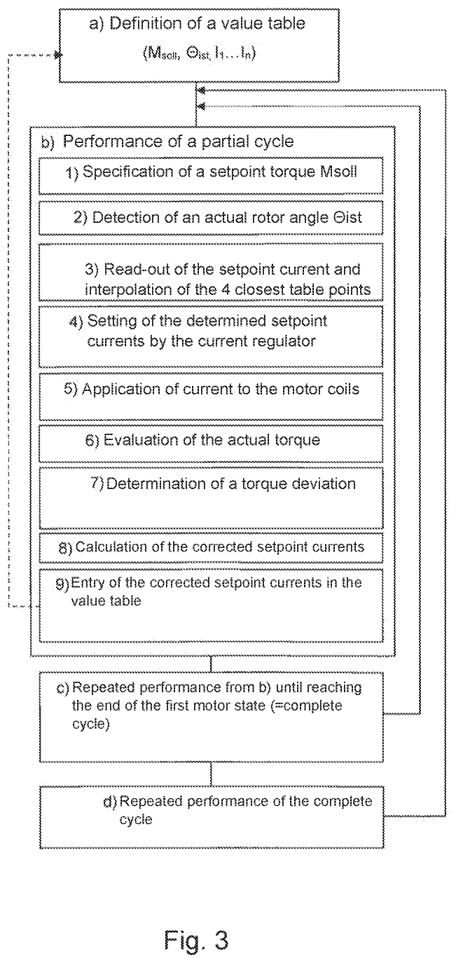

FIG. 3 Schematic flow chart of the method

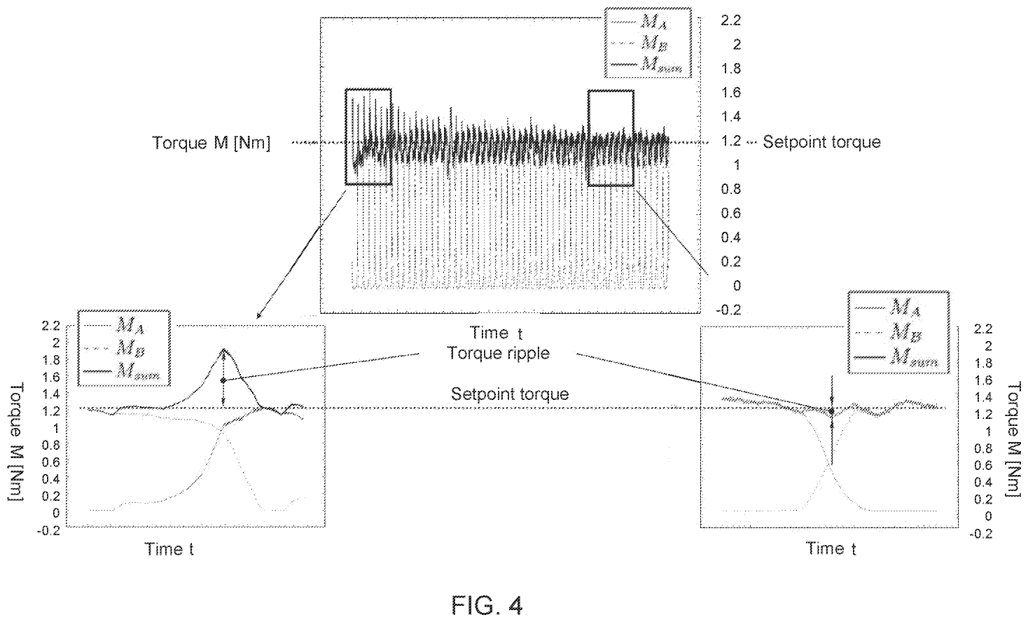

FIG. 4 Torque behaviour of a reluctance motor during the method

FIG. 4 Values, interpolation and calculation of the corrections.

FIG. 1 is a schematic representation of an electric-motor motor device, which in the embodiment example is designed as a household appliance driven by an electric motor. In the exemplary embodiment, it is a multifunctional appliance which is provided with interchangeable driven group of accessories. FIG. 1 shows the main body II, at which the electric motor assembly I and the driven group of accessories III are arranged. The driven group of accessories III comprises a transmission shaft which carries a food-crushing mechanism 10. In the exemplary embodiment, the food-crushing mechanism 10 is a rotating cutting blade.

FIG. 2 shows a schematic structure of the electric-motor assembly.

The electric-motor assembly comprises a control and evaluation unit 2, a data memory 3, a current regulator 4, a rotor angle sensor 5, a torque evaluator 6 and an electric motor 1.

The current regulator 4, the rotor angle sensor 5 and the torque evaluator 6 are each connected to the electric motor 1 and the control and evaluation unit 2.

In this embodiment, the data memory 3 with the value table is integrated in the control and evaluation unit 2.

The electric motor 1 comprises a stator 7, a rotor 8 and several motor coils 9.

The current regulator regulates the setpoint currents for the motor coils to the values transmitted by the control and evaluation unit.

The rotor angle sensor 5 determines the position of the rotor 8 and transmits it to the control and evaluation unit 2 and to the torque evaluator 6.

The torque evaluator 6 evaluates the actual torque referred to a specific rotor angle from the parameters applied to the electric motor 1, in the exemplary embodiment in particular from the actual current, and also transmits this value to the control and evaluation unit 2. Based on this value, the control and evaluation unit 2 calculates a torque deviation and, on this basis, optimized setpoint current values and enters them into the value table of the data memory 3 thus replacing the previous setpoint current values.

FIG. 3 is a schematic representation of the method for the noise-reduced operation of an electric-motor device. The flow chart shows a summary of all the procedural steps from a) to d), wherein the procedural step b) is shown with all its sub-steps. The partial cycle (procedural step b)) is repeated until the end of the first motor state is reached, and upon reaching the first motor state, it is repeated until the end of the next motor state is reached (procedural step c)). This is a complete cycle.

The complete cycle is repeated for all motor states until a complete 360° rotation of the rotor is achieved (procedural step d)). Once a complete rotation of the rotor has been terminated, the entire sequence can be repeated as often as required to effect a continuous rotation.

The value table is continuously updated in procedural step b)9.

FIG. 4 shows a compilation of graphs relating to the torque behaviour of the electric motor, in this embodiment a reluctance motor, during the application of the method. At the beginning (t=0 or on the left), the switched reluctance motor still shows high torque peaks, also known as torque ripples, which are caused by a suboptimal superposition of the partial torques, especially during the transition from one motor state to the next (at the bottom left). After several complete cycles, the torque peaks are significantly reduced (at the bottom right) and the partial torques overlap more advantageously. The torque peaks are responsible for a vibration of the rotor teeth and stator teeth and thus for the loud running noise of the reluctance motor. Hence, the reduction of the torque peaks also reduces the motor noise.

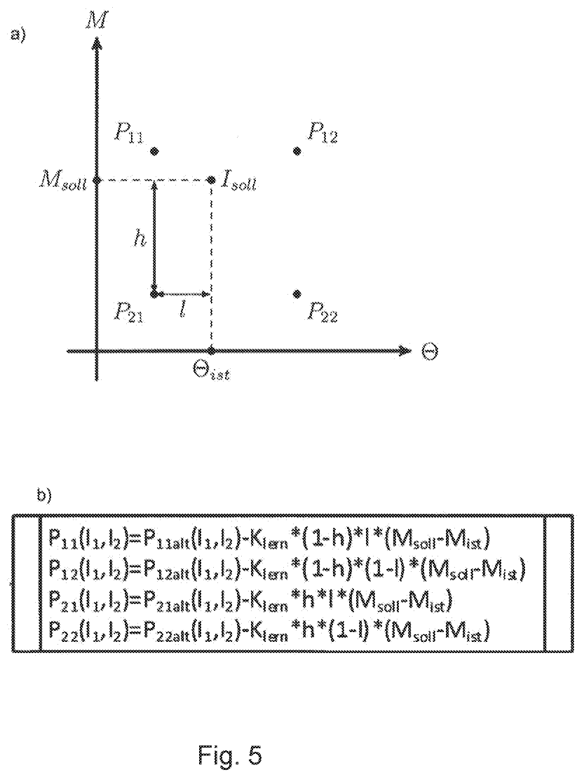

FIG. 5 shows the interpolation of the values in the coordinate system a) and the calculation of the corrections for the setpoint currents in table b).

The value interpolation according to procedural step b)3 is represented graphically in the coordinate system a). The control and evaluation unit is given the setpoint torque and the rotor angle sensor provides the actual rotor angle (Θᵢₛₜ). The control and evaluation unit determines the four closest table points (P11, P12, P21, P22) and interpolates a setpoint current (Iₛₒₗₗ) by bilinear interpolation. The value for a setpoint current (Iₛₒₗₗ) obtained in this way by interpolation is set by the current regulator in procedural steps b)4 and b)5 and transmitted to the motor coils.

In procedural step b)6, the torque evaluator evaluates the actual torque (Mᵢₛₜ) applied and, in procedural step b)7, the control and evaluation unit sets it off against the setpoint torque (Mₛₒₗₗ) to obtain a torque deviation (M_{Soll}-Mᵢₛₜ).

FIG. 5 shows in table b) the calculation formulas for the correction values (according to procedural step b)8) with the torque deviation on the basis of the interpolation distances (h, I) used, a learning constant (K_{Lern}) and the torque deviation (Mₛₒₗₗ-Mᵢₛₜ).

### LIST OF REFERENCE NUMERALS

I electric-motor assembly
II main body
III driven group of accessories
1 electric motor
2 control and evaluation unit
3 data memory
4 current regulator
5 rotor angle sensor
6 torque evaluator
7 stator
8 rotor
9 motor coils
10 food-crushing mechanism

1-6. (canceled)

7. A method for the vibration- and noise-reduced operation of an electric-motor device, comprising:
providing the electric motor device including an electric motor assembly, a main body and a driven group of accessories;
the electric motor assembly including an electric motor, a control and evaluation unit, a data memory, a current regulator, a rotor angle sensor and a torque evaluator, and
the electric motor having a stator, a rotor and motor coils;
including the following procedural steps:
a) defining a value table in the data memory including several table points, the table points being value tuples, each of the value tuples containing a pair of values from a setpoint torque, a rotor angle. and an assigned setpoint current;
b) performing a partial cycle, including the following sub-steps:
b1) providing specification of a setpoint torque;
b2) detecting a first actual rotor angle with the rotor angle sensor;
b3) the control and evaluation unit reading-out the setpoint current which is assigned to a first pair of values from the setpoint torque and the first actual rotor angle by determining two table points closest to a specified setpoint torque and two table points closest to the actual rotor angle and calculating a distance of real values of the setpoint torque and the first actual rotor angle to the two table points, determining a setpoint current by bilinear interpolation from respective setpoint currents of the four table points;
b4) setting the setpoint current with the current regulator;
b5) applying current to the motor coils;
b6) evaluating actual torque with the torque evaluator;
b7) comparing the setpoint torque and the actual torque with the control and evaluation unit for determining a torque deviation;
b8) calculating a corrected setpoint current with the control and evaluation unit, on the basis of the torque deviation, for all four table points most recently used as a function of interpolation distance used;
b9) entering the calculated values of the corrected setpoint current in four relevant value tuples of the value table with the control and evaluation unit and deleting previous values of the setpoint current;
c) repeating performance of the partial cycle until a rotor angle corresponding to a complete motor state is reached for forming a complete cycle;
d) repeating performance of a complete cycle.

8. The method for the vibration- and noise-reduced operation of an electric-motor device according to claim 7, wherein the value table is configured for a complete rotor rotation.

9. An electric-motor device, comprising:
a main body; a driven group of accessories; an electric-motor assembly including an electric motor, a control and evaluation unit, a data memory, a current regulator, a rotor angle sensor and a torque evaluator, said electric motor having a stator, a rotor and motor coils, said electric motor disposed in a positional relationship at the main body and rotationally driving said driven group of accessories;
said electric-motor assembly being configured for performing the following steps:
a) storing a value table in the data memory, the value table including table points, the table points being value tuples, each of the value tuples containing a pair of values from a setpoint torque and a rotor angle as well as an assigned setpoint current;
b) performing a partial cycle, including the following sub-steps:
b1) providing specification of a setpoint torque;
b2) detecting a first actual rotor angle with the rotor angle sensor;
b3) said control and evaluation unit reading-out the setpoint current which is assigned to a first pair of values from the setpoint torque and the first actual rotor angle, determining two table points closest to a specified setpoint torque and two table points closest to the actual rotor angle and calculating a distance of real values of the setpoint torque and the first actual rotor angle to the two table points, determining a setpoint current by bilinear interpolation from respective setpoint currents of the four table points;
b4) setting the setpoint current with said current regulator;
b5) applying current to said motor coils;
b6) evaluating actual torque with said torque evaluator;
b7) comparing the setpoint torque and the actual torque with said control and evaluation unit for determining a torque deviation;
b8) calculating a corrected setpoint current with said control and evaluation unit, on the basis of the torque deviation, for all four table points most recently used as a function of interpolation distance used;
b9) entering the calculated values of the corrected setpoint current in four relevant value tuples of the value table with the control and evaluation unit and deleting previous values of the setpoint current;
c) repeating performance of the partial cycle until a rotor angle corresponding to a complete motor state is reached for forming a complete cycle;
d) repeating performance of a complete cycle.

10. The electric-motor device according to claim 9, wherein said electric-motor device is constructed a household appliance.

11. The electric-motor device according to claim 10, wherein said driven group of accessories includes a food-crushing mechanism.

12. The electric-motor device according to claim 10, wherein said electric-motor device is constructed as an electric vehicle roof.
